(19) United States
(12) Patent Application Publication
(10) Pub. No.: US 2023/0373363 A1
(43) Pub. Date: Nov. 23, 2023

(54) CHILD SEAT WITH AN IMPACT SHIELD FOR MOUNTING ON A MOTOR VEHICLE SEAT

(71) Applicant: CYBEX GmbH, Bayreuth (DE)

(72) Inventors: Christoph THURN, Bayreuth (DE); Thomas MÜLLER, Bayreuth (DE); Iain POWELL, Bayreuth (DE)

(21) Appl. No.: 18/250,950

(22) PCT Filed: Oct. 25, 2021
(86) PCT No.: PCT/EP2021/079526

§ 371 Date: Apr. 27, 2023

(30) Foreign Application Priority Data
Oct. 30, 2020 (DE) 20 2020 106 242.5

(51) Int. Cl. B60N 2/28

(52) U.S. Cl. CPC B60N 2/2839; B60N 2/2884

(57) ABSTRACT

The invention relates to a child seat, wherein the child seat comprises a main body for receiving a child and an impact shield for holding the child, wherein the child seat is configured such that a center of gravity of the child, at least in an initial state at the beginning of a sudden deceleration of the motor vehicle and/or at the beginning of a rotation of the child relative to the vehicle seat and/or at the beginning of a rotation of the child relative to the main body during a sudden deceleration of the motor vehicle, for example in the event of a frontal impact, is at least approximately at or below, preferably slightly below, a level at which a child rotation axis is located, about which rotation axis the child rotates with respect to the main body, as soon as the child starts to rotate with respect to the main body, and/or is at least approximately at or below, preferably slightly below, a level at which at least one impact shield rotation axis is located about which the impact shield can rotate with respect to the main body.

The invention relates to a system comprising a motor vehicle as well as a child seat arranged on a vehicle seat of the motor vehicle, the corresponding child seat and a method for arranging a child seat on a vehicle seat of a motor vehicle.

A child seat for a motor vehicle with an impact shield is described, for example, in DE 20 2012 102 223 U1. There, it is proposed to provide not only one transverse belt section, but two transverse belt sections for holding the impact shield or the child, whereby the two belt sections are offset from each other. By this a rotation of the child shall be counteracted (compared to a solution with only one transverse belt section). However, this solution is still considered to be in need of improvement in terms of design and safety.

It is therefore in particular an object of the invention to propose a child seat for a motor vehicle with an impact shield which holds the child securely in the child seat or on the vehicle seat in a comparatively simple manner. In particular, risks in connection with a rotation of the child (or its upper body) in the event of an accident are to be reduced as far as possible. Furthermore, it is an object of the invention to propose a corresponding system comprising a child seat and a motor vehicle as well as a method for arranging a child seat on a vehicle seat of a motor vehicle.

In particular, the object is solved by a system comprising a vehicle, in particular a motor vehicle, as well as a child seat arranged on a vehicle seat of the vehicle, in particular a motor vehicle, wherein the child seat has a main body for accommodating a child and an impact shield for holding the child, wherein the child seat is configured in such a way that a centre of gravity of the child, at least in an initial state, at the beginning of a rotation of the child (in particular relative to the vehicle seat, optionally together with the main body) and/or at the beginning of a rotation of the child relative to the main body in the event of a (particularly sudden) deceleration of the (motor) vehicle or in the event of a frontal impact (collision with a structure in front of the vehicle), is at least approximately at or, preferably slightly, below a level at which a child rotation axis lies about which the child rotates relative to the main body as soon as the child starts to rotate relative to the main body, and/or is (at least approximately) at or (preferably only slightly) below a level at which at least one impact shield rotation axis lies about which the impact shield can rotate relative to the main body.

A core idea of the invention is to configure the child seat in such a way that, in the case of a (usual) assembly or arrangement on a motor vehicle vehicle seat for the child, a child rotation axis or impact shield rotation axis is formed in such a way that the centre of gravity of the child lies (at least approximately) at or (preferably slightly) below a level of the respective rotation axis. In this way, an (excessive) rotation of the child can be prevented in a comparatively simple manner. Further constructional measures (such as, for example, rotation-preventing additional structures, as described, for example, in DE 20 2012 102 223 U1) can thereby be omitted if necessary. Overall, a safety improvement is achieved in a constructively simple manner.

A level at which the respective rotation axis lies is to be understood in particular as a horizontal plane in which the respective rotation axis lies. The child's centre of gravity should lie “approximately” at this level (or in the corresponding horizontal plane) if the centre of gravity deviates (upwards and/or downwards) from this level by a maximum of 8 cm, preferably a maximum of 5 cm, even further preferably a maximum of 2 cm, possibly a maximum of 1 cm.

In particular, the centre of gravity of the child is to be considered “slightly” below the respective level (or a corresponding level) if it is below the respective level by a maximum of 10 cm, preferably a maximum of 7 cm, possibly a maximum of 3 cm, and/or is below this level by at least 0.5 cm or at least 1 cm.

In any case, by an arrangement at least approximately at or (only slightly) below said level it is achieves that the child rotates comparatively little (for example, under the impact shield or over the impact shield).

In particular, the child-rotation axis is intended to be the rotation axis (possibly one of the rotation axes) about which the child rotates (at a given time) relative to the main body, in particular (at least) at the beginning of a rotation of the child. In some embodiments, a child rotation axis may be considered to be an upper rear edge of the impact shield.

In particular, the impact shield rotation axis is intended to be the rotation axis (possibly one of the rotation axes) about which the impact shield rotates (at a given time) relative to the main body. In some embodiments, the impact shield rotation axis (or axes) may also form the child rotation axis (axes).

The child and/or impact shield rotation axis (hereinafter in short: “the rotation axis” or “the respective rotation axis”) may remain at the same location throughout the entire rotation of the child and/or the impact shield (relative to a main body, possibly also relative to the vehicle seat, for example if the latter is designed to be at least essentially unyielding or rigid and/or rotation-avoiding measures are taken relative to the child seat, such as in the form of a support foot) or may shift.

If the respective rotation axis and/or the centre of gravity of the child (in terms of height relative to a lowermost point of the child seat and/or the main body and/or in terms of distance relative to a foremost point of the child seat and/or the main body, relative to a projection on a horizontal plane) shifts/relocates, the respective (geometric) condition (for the arrangement of centre of gravity relative to rotation axis described above, but also for subsequently defined conditions of the centre of gravity relative to an rotation axis or different rotation axes relative to each other) shall preferably apply to a rotation angle range (a rotation of the main body relative to the vehicle seat and/or a rotation of the impact shield relative to the main body) of at least 5°, preferably at least 10° and/or at most 20°.

Insofar as further definitions or preferred geometric relationships of the centre of gravity of the child relative to a respective rotation axis (or several rotation axes considered against each other) are defined above and/or further below, the respective condition shall—unless explicitly stated otherwise—preferably be fulfilled at least at the beginning of a respective rotation of the child or impact shield in the event of a (sudden) deceleration of the motor vehicle, for example in the event of a frontal impact, but if necessary also over a further course of the respective rotation.

In general, the child seat according to the invention is a child seat which is configured for arrangement (mounting) on a vehicle seat of a (motor) vehicle (e.g. car or truck). The child seat comprises a main body (in particular comprising a seating section) and an impact shield. The seating section may define a seating area and (optionally) a left and/or right support section (in particular for supporting or bracing the impact shield and/or for laterally supporting the child in case of lateral movements or lateral accelerations, for example in case of a side impact).

The main body may comprise a first fastening means (for example an Isofix fastening means and/or a Latch fastening means) to attach the child seat to the vehicle seat.

The child seat may include at least one guide mechanism for guiding a vehicle belt such that the child seat may be secured to the vehicle seat (for example, the main body may include a corresponding guide mechanism for guiding the vehicle belt such that the main body may be secured to the vehicle seat and/or the impact shield may include at least one corresponding guide mechanism for guiding the vehicle belt such that both the main body as well as the impact shield are held to the vehicle seat).

The child seat may comprise a backrest, a headrest, side elements (side wings) for laterally supporting the child (for example in the event of a side impact), a support leg, a top tether, and/or a base.

A impact shield is preferably intended to mean a device that is (preferably at least partially detachably, in particular removably) attachable to the main body of the child seat to hold the child against the main body. The impact shield is preferably (at least partially) dimensionally stable (in particular in the sense that it does not collapse under its own weight and/or when subjected to only minor external forces).

The impact shield may be made of plastic (at least proportionate, for example at least 80% by weight) and/or comprise a cushion (e.g. foam cushion). The impact shield may be formed of at least 30% by weight, preferably at least 60% by weight, of a solid and/or non-porous material (plastic). The impact shield may be formed of at least 30% by volume, preferably at least 60% by volume, of a porous material (in particular foamed plastic, e.g. EPS or EPP). The impact shield may weigh at least 200 g or at least 500 g and/or at most 5 kg or at most 2 kg.

The impact shield may comprise a middle section that is configured to restrain the child (in particular at least relative to a forward acceleration of the child relative to the vehicle seat). Alternatively or additionally, the impact shield may comprise at least one lateral (preferably a left and a right) section (holding section/restraining section), which is preferably configured to be support on corresponding (lateral) support sections of the main body.

The impact shield may comprise at least one guide mechanism to guide a vehicle belt accordingly so that the impact shield (in particular both the main body as well as the impact shield) can be secured to the vehicle seat and, if applicable, the impact shield can be secured to the main body at the same time.

The child seat is preferably configured for forward-facing placement on the vehicle seat (so that the child faces in the direction of travel). In particular, a direction of travel is understood to mean a movement of the vehicle in a straight-ahead direction, as a child seated in the child seat (when facing straight ahead) faces in the direction of travel. When the vehicle (travelling straight ahead) is subjected to a (sudden) deceleration, for example due to a frontal collision, the child and child seat are subjected to inertial forces acting in the direction of travel.

In general, the indications ‘left’ and ‘right’ should preferably be understood in relation to the direction of travel (so that, in particular, the child's left shoulder is on the left and the child's right shoulder is on the right). Indications such as up or down, above/upper or below/under, upper/top or lower/bottom, horizontal or vertical shall preferably be understood in relation to the direction of the gravity vector. If dynamic situations are described, the corresponding indications shall preferably apply at least to a point in time when a rotation of the child or the impact shield, e.g. relative to the main body (in case of deceleration relative to the motor vehicle), starts and/or when there is a normal situation of use with no or only slight (or usual in traffic) accelerations (as opposed to a sudden deceleration).

An inner surface of the impact shield shall in particular be the surface facing towards the child, in particular towards an abdomen of the child. An outer surface of the impact shield shall in particular be a surface directed away from the child's abdomen. It is possible (but not necessary) that such surfaces are flat and/or without (possibly at least without significant) protrusions and/or recesses.

A normal use situation shall in particular be understood to mean a situation where the child seat is arranged (mounted) on the vehicle seat (and in particular according to the instructions of the child seat manufacturer) and where a child is safely supported by and held by the child seat (in particular according to the instructions of the child seat manufacturer).

The seating area of a vehicle seat of the motor vehicle (on which the child seat is arranged or mounted) may have an inclination (in particular rising from the rear to the front) of 0 to 30°, preferably 8 to 22°, still more preferably 12 to 18°, for example (at least about) 15°.

The child seat has an underside which is towards the seating surface of the vehicle seat when the child seat is mounted on the vehicle seat.

Taking a placement of the child seat on a flat horizontal surface as a starting point, the child seat may be oriented as it would be oriented if it were placed on a flat surface having an angle of between 0 and 30°, preferably 8 and 22°, still further preferably 12 and 18°, still further preferably (at least approximately) 15°, relative to the horizontal flat starting surface.

By a sudden deceleration (or an event with a sudden deceleration) shall be understood in particular an event in which high accelerations (or decelerations) occur, compared to a normal journey in a vehicle (e.g. passenger car). In particular, a collision (frontal impact), or any other accident shall be understood as an event with sudden deceleration. In particular, such a deceleration can be understood as a sudden deceleration event if the accelerations (or decelerations) are so high that an active protective device, such as an airbag, is triggered in the motor vehicle. Decelerations during a sudden deceleration event may possibly exceed 2 g, possibly even 3 g or even 5 g or even 8 g (or be understood as a corresponding sudden deceleration event if these limits are exceeded). In particular, an impact (“crash”) as described as a “frontal crash” in UN ECE-R44 or in UN ECE-R129 (valid at application or priority date, respectively, retrievable e.g. on the UNECE website www.unece.org) shall be understood as a sudden deceleration event.

Generally, child seats with impact shield have proven to be advantageous compared to child seats with an (integral) belt (or child seats without impact shield), which is shown, for example, in particularly good results that such child seats (with impact shield) have achieved with consumer organisations in the past (especially in terms of safety). For example, in a study by Stiftung Warentest (published in June 2019), the five highest-rated child seats (for children weighing between 9 and 36 kg) were child seats with impact shield. Nevertheless, child seats with impact shield do not dominate the market. Child seats without impact shield are still widespread. This is possibly also due to the fact that the known constructive solutions (with high safety requirements) are comparatively elaborate.

According to the invention, by a comparatively simple measure it is achieved that even higher safety requirements can be met. Basically it has been taken into account that child seats with impact shield possibly allow a rotation of the (restrained) child. Such a rotation may cause the child to rotate under the impact shield or over the impact shield, depending on a position of the child's centre of gravity in relation to potential rotation axes for the child's rotation. In general, the child may rotate together with the impact shield and/or relative to the impact shield. Potential rotation axes may depend on the attachment of the impact shield to the main body, in particular relative to remaining degrees of freedom and/or may depend on an impact shield geometry.

The main body may comprise at least one seating section defining a seating area on which the child may sit as well as lateral support sections preferably for laterally supporting the child.

The impact shield may have at least a middle section for holding the child and (optionally) lateral sections which preferably (may) support themselves on the supporting sections of the main body.

A front section of a (particularly the above) seating area of the main body may have a (preferably centrally located) elevation for restraining the child. The elevation (bulge) may be positioned so that it is located between the child's thighs and/or below the impact shield. The elevation may be high enough to come into contact (when the impact shield is in use) with the impact shield. Alternatively or additionally (for example in the case of an adjustable impact shield), a gap may be left between the elevation and the impact shield. The elevation may help to prevent the child rotates under the impact shield (together with the impact shield or in relation to the impact shield). The elevation may be at least 1 cm or at least 2 cm and/or at most 10 cm. The elevation may have an area (in a projection on its base) of at least 5 cm² or at least 10 cm² and/or at most 200 cm² or at most 100 cm². The elevation may be covered by a cover (e.g. textile cover) and thus not or hardly visible during normal use of the child.

The child seat, in particular the main body thereof, may comprise a first fastening means (preferably an Isofix fastening means and/or a Latch fastening means) for fastening the child seat (or main body) to the vehicle seat, in particular to a first fastening device of the vehicle seat. The first fastening means may comprise at least (or exactly) two fastening structures (e.g. Isofix anchorage structures). The first fastening means may be configured such that it allows a rotation of the child seat about a child seat rotation axis (relative to the vehicle seat). The first fastening means may in particular comprise Isofix anchorage structures and/or Latch anchorage structures and/or may comprise anchorage structures for a vehicle belt. A child seat rotation (about the child seat rotation axis) may be limited, for example, by a seating section and/or a back section of the vehicle seat and/or by a support leg and/or a top tether and/or other device. By a child seat rotation axis is meant in particular an axis about which the child seat or at least its main body rotates in the event of a (sudden) deceleration of the motor vehicle. Such a child seat rotation axis can preferably run through the first fastening means (e.g. Isofix anchorage structures).

The child seat (for example, its main body and/or impact shield) may comprise at least one guide mechanism for receiving a motor vehicle belt such that the child seat is attachable to the motor vehicle seat.

The child seat (in particular its main body) may be rotatable about a child seat rotation axis or main body rotation axis relative to the vehicle seat.

In embodiments, the impact shield may be connected or connectable to the main body at least substantially rigidly (but preferably detachable at least in sections, in particular removable and/or non-destructively detachable, preferably detachable without tools) relative to rotation. Alternatively or additionally, the impact shield may be connected or connectable to the main body at least substantially rigidly (but preferably detachable at least in sections, in particular removable and/or non-destructively detachable, preferably detachable without tools) relative to a translation. By an at least substantially rigid connection to the main body, it is to be understood in particular that the connection structure per se is configured such that it prevents or is capable of preventing a relative rotation or relative translation of the impact shield relative to the main body.

A relative rotation or relative translation of the impact shield can thus be hindered relative to the main body (apart from unavoidable bending or deformation of the moulded body or main body in the case of high accelerations). At least a (possibly unavoidable) deformation should be so small that the impact shield (in particular no section or point of the impact shield) is pivoted by an angle greater than 20°, or greater than 10°, relative to the main body. In a case of a rigid configuration of the impact shield, at least relative to rotation, the child may rotate about the impact shield upon a sudden deceleration (depending on the geometry of the impact shield and/or the position of the child's centre of gravity relative to the impact shield). In this case, the child rotation axis may be defined by a line (edge) of the impact shield and/or move on the (inner and/or upper) impact shield surface during the rotation of the child. For example, the child rotation axis (at the beginning of the rotation) may be defined by an upper, inner edge of the impact shield.

The child rotation axis may lie on a surface of the impact shield, preferably, at least at the beginning of the child's rotation, at an inner surface, and/or, at least in the course of the rotation, at an upper surface (or exactly between upper and inner surface). Alternatively or additionally, the child rotation axis during the rotation of the child may shift at least in phases (possibly at least in the initial phase of the rotation) and/or remain stationary (at least in phases, possibly at least in an initial phase of the rotation).

In embodiments, the child rotation axis may coincide with at least or exactly one impact shield rotation axis.

In further embodiments, the impact shield may be rotatably connected or connectable to the main body (possibly, however, without allowing—in the connected or mounted state—a pure translation, at least in a direction away from and/or towards the main body). The impact shield may be rotatably connected or connectable to the main body about (exactly) one rotation axis or (exactly) two rotation axes or more than two rotation axes.

In general, a translational movement of the impact shield in relation to the main body—in the mounted state—can be blocked or at least limited (but not completely blocked).

The connection between impact shield and main body can also define basically existing rotation axes which, however, can again be (possibly completely) blocked and/or blockable (for example by corresponding engagement of structures of the main body on the one hand and of the impact shield on the other hand and/or by the formation of stops and/or support surfaces or the like which prevent a rotation—possibly completely). However, unless otherwise stated below, mentioned rotation axes should always allow at least some rotation (which may be restricted). This may also include, for example, that although the impact shield is directly adjacent to a corresponding structure of the main body and is pressed against it (in case of a rotation), this structure yields in such a way that a (substantial) rotation of the impact shield relative to the main body can take place.

In embodiments, the child seat comprises at least one impact shield fastening means for fastening the impact shield to the main body.

The impact shield fastening means may allow a rotation of the impact shield (relative to the main body) about exactly one or exactly two or more than two rotation axes.

The impact shield fastening means may have at least one first section, preferably at least one or exactly one first section on each side of the main body that is linked or linkable to the main body, and/or a second section, preferably at least one or exactly one second section on each side of the impact shield that is linked to the impact shield. By a link on the main body or impact shield it is to be understood in particular that a joint (rotary joint) permitting a rotation is arranged or can be arranged in a stationary manner on the respective part (main body or impact shield). For example, the link to the main body can also be effected by an element that is (rigidly) connectable to (but detachable from) the main body, for example a belt tongue. A joint is preferably understood to mean any connecting structure that allows relative rotation (for example, also a belt in an eyelet of a belt tongue, which would allow that the belt rotates due to its nature in the area of the eyelet, for example by twisting).

In embodiments, at least one (or exactly one or exactly two, for example one on each side) articulated joint may be provided in a connecting section between the main body and the impact shield.

The impact shield fastening means may (at least in sections, possibly completely) be rigid (possibly apart from corresponding articulated connections, but possibly also completely rigid).

The impact shield fastening means can also be (at least in sections, possibly completely) is designed dimensionally unstable, for example having at least one belt (or belt section).

In general, the impact shield may be rotatable about at least one (or exactly one) or at least two (or exactly two) or at least three (or exactly three) impact shield rotation axis (axes) relative to the main body. Preferably, the impact shield is rotatable about at least one (or exactly one) first and/or at least one (or exactly one) second impact shield rotation axis and/or at least one (or exactly one) third impact shield rotation axis relative to the main body.

A (respective) second and/or third impact shield rotation axis preferably deviates (at least at the beginning of a rotation of the child and/or at least at the beginning of a rotation of the child relative to the main body) from the (respective) first impact shield rotation axis. A (respective) second impact shield rotation axis preferably deviates (at least at the beginning of a rotation of the child and/or at least at the beginning of a rotation of the child relative to the main body) from a (respective) third impact shield rotation axis.

The second impact shield rotation axis is preferably located above a level of the first impact shield rotation axis (at least at the beginning of a child's rotation and/or at the beginning of a child's rotation relative to the main body). Alternatively or additionally, the second impact shield rotation axis is preferably in front of the first impact shield rotation axis (at least at one of the two aforementioned points in time, as far as the two points in time diverge). By an impact shield rotation axis is to be understood in particular an rotation axis about which the impact shield can rotate, that is relative to the main body.

Generally, only the first or only the second impact shield rotation axis may be provided. Alternatively, first and second impact shield rotation axes may be provided (but possibly no further impact shield rotation axis). In still further embodiments, in addition to the first and second impact shield rotation axes, further impact shield rotation axes may be provided, for example at least one (or exactly one) third impact shield rotation axis.

The first impact shield rotation axis is preferably defined by a link to the main body (and possibly additionally by a link to the impact shield or without a link to the impact shield). Under a link to the respective device (e.g. main body or impact shield) it is in particular to be understood that a joint forming the link is stationary relative to the respective device (main body or impact shield). Stationary is intended to mean in particular that no or at most an insignificant movement is possible, for example by at most 3 cm. If, for example, in the present case the first impact shield rotation axis is to be defined by a link to the main body, this should imply in particular that the impact shield rotation axis per se cannot move or can only move insignificantly relative to the main body.

In general, an impact shield rotation axis can be assigned to one of four types (which can be understood as conclusive or non-conclusive). A first type is characterised in that the corresponding impact shield rotation axis is immobile (or stationary) relative to the main body. A second type is characterised by the fact that the corresponding impact shield rotation axis per se is not movable relative to the impact shield (or is stationary relative to the latter). A third type is characterised in that the corresponding impact shield rotation axis is movable per se relative to both the main body as well as the impact shield (for example, in a case where such a third impact shield rotation axis is located between a first and a second impact shield rotation axis). In a fourth type (which again can be considered as a subtype of both the first type as well as of the second type), the impact shield rotation axis is both stationary (not movable per se) relative to the main body as well as relative to the impact shield (which means in particular that—at least in a functional view—there is exactly one impact shield rotation axis).

The second impact shield rotation axis is preferably defined by a link of a connecting device (e.g. belt or belt section) for the connection between main body and impact shield to the impact shield.

In embodiments, the centre of gravity of the child (at least at the beginning of a rotation of the child relative to the vehicle seat and/or at the beginning of a rotation of the child relative to the main body) lies at least approximately at the level of or (preferably at least slightly) below a level of the second impact shield rotation axis and/or behind the second impact shield rotation axis (wherein the second impact shield rotation axis can be the only impact shield rotation axis or possibly the uppermost and/or foremost impact shield rotation axis at the respective time considered).

The centre of gravity of the child lies preferably (at least at the beginning of a rotation of the child relative to the vehicle seat and/or at the beginning of a rotation of the child relative to the impact shield) at least approximately at the level (on the level) of the first impact shield rotation axis or (according to a particularly preferred embodiment) above or (in an alternative embodiment) below a level of the first impact shield rotation axis and/or in front of the first impact shield rotation axis (alternatively behind or at the same level relative to the direction from front to rear).

A connecting line connecting and perpendicular to the first and second impact shield rotation axes preferably has an angle of less than 60°, preferably less than 50° and/or more than 10° relative to the underside of the child seat. Alternatively or additionally, such a connecting line is oriented (at least substantially) parallel to at least one support surface on which the impact shield is supported on the main body (and/or at least substantially parallel to at least one cross-sectional line through such a support surface relative to a section in a vertical and/or front-to-rear plane). Substantially parallel preferably includes angular deviations of maximum 20° or maximum 10° or maximum 5° relative to an exactly parallel configuration.

A rotation of the impact shield about the first impact shield rotation axis preferably results (at least at the beginning of such rotation) in the impact shield exerting a force on a (in particular the above) support surface on which the impact shield is supported on the main body, wherein this force preferably is directed at least substantially perpendicularly to the support surface. Substantially perpendicular preferably comprises angular deviations of maximum 20° or maximum 10° or maximum 5° relative to an exactly perpendicular configuration.

The first impact shield rotation axis may be arranged above a lower end of the impact shield (at least at the beginning of a rotation of the child relative to the vehicle seat and/or at the beginning of a rotation of the child relative to the main body) and/or above a lower end of a (in particular the above) support surface at which the impact shield is supported on the main body.

The first and/or second impact shield rotation axis (axes) is (are) arranged above a child seat rotation axis, preferably main body rotation axis, about which the child seat or its main body rotates relative to the vehicle seat.

Preferably, the child seat is configured in such a way that a centre of gravity of the child remains at least approximately at a level of the child rotation axis and/or at least one (in particular uppermost in the initial state) impact shield rotation axis during the rotation or (if necessary also in combination, for example during another phase of the rotation) moves upwards relative to the level of the child rotation axis and/or at least one (in particular uppermost in the initial state) impact shield rotation axis. Particularly preferably, the centre of gravity of the child moves during the rotation (at least in phases) from an initial position at least slightly below the respective level to an intermediate and/or final state at least slightly above this level. With such a dynamic, the child can be restrained particularly safely and effectively with simple measures.

The system or the child seat can be configured in such a way that during a progressive rotation of the child at least or exactly one reversal of the direction of rotation of the child (relative to the main body and/or the motor vehicle) takes place.

Particularly preferably, the child or a corresponding dummy is part of the system. Further preferably, the child (or the dummy) is positioned in the child seat (in particular secured, that is by a securing positioning and adjustment of the impact shield).

The above-mentioned object is further solved by a child seat, in particular for the above system (or as a component of the above system), for mounting on a motor vehicle seat, wherein the child seat comprises a main body for receiving a child and an impact shield for holding the child, whereby the child seat is configured in such a way that a centre of gravity of the child, at least in an initial state at the beginning of a rotation of the child (relative to the vehicle seat or the motor vehicle) and/or at the beginning of a rotation of the child (relative to the vehicle seat or the motor vehicle) and/or at the beginning of a rotation of the child relative to the main body during a (sudden) deceleration of the motor vehicle, for example in the case of a frontal impact, lies at least approximately at or (preferably slightly) below a level at which a child rotation axis lies about which the child rotates relative to the main body as soon as the child starts to rotate relative to the main body, and/or is at least approximately at or (preferably slightly) below a level at which at least one impact shield rotation axis is located, preferably at least when the child seat is arranged on a motor vehicle seating surface such that the child seat is inclined about an angle of at least 0° and at most 30°, preferably at least 8° and at most 22°, still further preferably at least 12° and at most 18°, for example at least approximately 15°, relative to the horizontal (or in a state in which the child seat is arranged on a horizontal flat plane). The above (respective) geometric conditions shall preferably apply to at least one angle in the respective angular range, but can possibly also apply to the entire respective angular range.

Further features result from the above description of the system. The child seat according to the invention preferably has the child seat features described above, wherein in particular a motor vehicle can be taken as a basis which (hypothetically) has the above features or which has a motor vehicle seating surface on which the child seat shall be mountable, which has an angle of at least 0° and at most 30°, preferably at least 8° and at most 22°, still further preferably at least 12° and at most 18°, for example at least approximately 15°. The (respective) geometric conditions shall preferably apply to at least one angle in the respective angular range, but may optionally also apply to the entire respective angular range.

Furthermore, the above object is solved by a method for arranging a child seat on a vehicle seat of a motor vehicle, preferably with provision of the above system and/or with provision of the above child seat, wherein the child seat comprises a main body for accommodating a child and an impact shield for holding the child, wherein the child seat is configured and arranged in such a way that a centre of gravity of the child at least in an initial state at the beginning of a rotation of the child (relative to the vehicle seat or relative to the motor vehicle) and/or at the beginning of a rotation of the child relative to the main body during a deceleration of the motor vehicle, for example in a frontal impact, is at least approximately at or (preferably slightly) below a level at which a child rotation axis about which the child rotates relative to the main body as soon as the child starts to rotate relative to the main body and/or is at least approximately at or (preferably slightly) below a level at which at least one impact shield rotation axis is located. The method may comprise a step of arranging, in particular securing, the child in the child seat.

Further, the above object is solved by a method for holding a child seat as well as a child being present therein during a frontal impact, by the above child seat and/or by the above system and/or following the above method for arranging. When dynamic changes of geometric relationships are described above, the method for holding shall preferably undergo these dynamic changes.

Further process features result from the above (and following) explanations of the system or child seat. Corresponding functional features can preferably be carried out as specific process steps. Thus, if for example, a rotatability is mentioned above, this can specifically mean that the method comprises the corresponding rotation (as an operation).

In embodiments, the attachment of the child seat to the vehicle seat defines a child seat rotation axis with (at least, preferably exactly) two first connection points, so that the child seat can rotate around this first axis. The (at least) two first connection points can be realised e.g. by the Isofix or LATCH anchorage points or the anchorage points of a vehicle lap belt. The rotation about the child seat rotation axis may be limited, e.g. by a seat part and a backrest of the vehicle seat and/or by a support leg, a top tether, etc.

In first embodiments, the impact shield may (releasably, in particular completely releasably) be that rigidly attached to the main body of the child seat that a rotation, preferably also displacement, of the impact shield relative to the main body is substantially precluded.

Then, in case of a sudden deceleration, the child can rotate around the impact shield (depending on the geometry of the impact shield and the position of the child's centre of gravity in relation to the impact shield). The child's rotation axis can be a defined line (edge) of the impact shield or move on the (inner and/or upper) impact shield surface (or impact shield side) during the child's rotation.

The geometry and position of the impact shield are particularly preferred to be chosen such that the child's centre of gravity is within a horizontal plane through the child's rotation axis or slightly below such a horizontal plane.

In other embodiments (in particular second and/or third embodiments, as further described below), the impact shield may be attached (possibly releasably, in particular completely releasably) to the main body of the child seat by an impact shield fastening means in such a way that a displacement of the impact shield relative to the main body is limited or, preferably, at least substantially impossible, while the fastening allows a rotation of the impact shield relative to the main body and a number of axes (at least one axis) is defined therefor. A part of the number of defined axes can be blocked, e.g. by positive connection (e.g. between impact shield and main body); however, if the entire number of defined axes is blocked, the system comprising the impact shield and the main body is (functionally) reduced to the first embodiment.

One (or more) first part(s) of the impact shield fastening means may be formed by the main body (e.g. integrally moulded thereto), preferably in or at least close to a left or right support section, respectively. The (respective) first part of the impact shield fastening means may also be connected or connectable to the main body (preferably in or at least close to a left or right support section, respectively) at a respective second connection point (e.g. belt buckle). The (respective) first part of the impact shield fastening means may be rotatable about an axis through which the respective connection points pass and define a first impact shield rotation axis (or be rigidly connected to the main body).

One (or more) second part(s) of the impact shield fastening means may be formed by the impact shield (e.g. integrally moulded thereto) (preferably on a left or right lateral section of the impact shield, respectively). Alternatively, the (respective) second part of the fastening means can be formed in a respective third connection point (preferably exactly two, in particular one each on the left and right) on the impact shield. The (respective) second part of the impact shield fastening means can be rotatable about an axis passing through the corresponding connection points and thus define a second impact shield rotation axis or be fixedly (rigidly) connected to the impact shield.

The (respective) first and second parts of the impact shield fastening means may be configured in such a way that they cooperate with each other at a respective fourth connection point (connection place) such that the impact shield is attached to the main body. When the first and second parts of the impact shield fastening means are operatively connected to each other, the (respective) first and second parts of the impact shield fastening means may be rotatable relative to each other about an axis, thereby defining a third impact shield rotation axis (or be rigidly formed).

In second embodiments, the attachment of the impact shield to the main body may allow a rotation about only one impact shield rotation axis, wherein further (blocked) axes may be defined by the impact shield fastening means. The one impact shield axis may be the above (first, second or third) impact shield axis. Two or more of the impact shield axes may coincide to form a common (single) rotation axis.

In an embodiment with (functionally) only one impact shield rotation axis, the respective first part of the impact shield fastening means may be rotatably connected to the main body and the (respective) second part of the impact shield fastening means may be rotatably connected to the impact shield, wherein corresponding connection points are provided such that the first and second impact shield rotation axes coincide. This (coevent) axis may (functionally) be the only possible axis for the rotation of the impact shield relative to the main body (at least if a possible operative connection between the respective first and second sections of the impact shield fastening means forms a rigid connection and/or coincides with the respective coevent rotation axes). When referring here, above and hereinafter to a rigid (and/or fixed) connection, this may mean a dimensionally stable connection, but possibly also a dimensionally unstable connection, which is such that it behaves like a dimensionally stable connection (e.g. is tightened) in the event of a sudden deceleration (or at least in this case retains its shape).

In the second embodiments, the (respective) first part of the impact shield fastening means may be rotatably attached (around a first impact shield rotation axis) around the main body and the (respective) second part of the impact shield fastening means may be rigidly attached to the impact shield.

Further, the (respective) first part of the impact shield fastening means may be fixedly attached to the main body and the (respective) second part of the impact shield fastening means may be rotatably attached to the impact shield (about a second impact shield rotation axis). Again, the resulting first or second impact shield rotation axis would be the only (possible) axis for a rotation of the impact shield relative to the main body (provided that a connection between the (respective) first and second parts of the impact shield fastening means forms a fixed connection or coincides with the first or second impact shield rotation axis, respectively).

Further, the (respective) first part of the impact shield fastening means may be rigidly (fixedly) attached to the main body and the (respective) second part of the impact shield fastening means may be rigidly attached to the impact shield, wherein the (respective) first part and the (respective) second part of the impact shield fastening means are configured to interact with each other so as to allow a rotation of the impact shield about the third impact shield rotation axis. Again, the third impact shield rotation axis may be the only possible rotation axis for the impact shield relative to the main body (for example, when impact shield and main body are pivotally attached to each other, e.g. via pins in fixed bearings). Pins and/or bearings may, preferably, be arranged in the left and right lateral sections of the impact shield, respectively.

In third embodiments, the attachment of the impact shield to the main body may enable rotation about two (diverging) axes, wherein further blocked axes may possibly be defined by the impact shield fastening means.

The two axes may comprise a first impact shield rotation axis and/or a second impact shield rotation axis and/or a third impact shield rotation axis. Two or more of the axes may coincide to collectively form one of the two axes.

A third embodiment may be realised when both the first impact shield rotation axis and the second impact shield rotation axis are present (and do not coincide) while a rigid connection is present between the (respective) first and second parts of the impact shield fastener.

An (at least substantially) same result can be achieved when the first, second and third impact shield rotation axes are present, wherein two of these axes coincide and the further impact shield rotation axis is separate from (or not coinciding with) the coinciding impact shield rotation axis. Preferably, in such a case, the third impact shield rotation axis may coincide with one of the first and second impact shield rotation axes.

Furthermore, another possibility (with at least substantially the same result) is that the (respective) first part of the impact shield fastening means is rotatably (about a first impact shield axis) attached to the main body and the (respective) second part of the impact shield fastening means is rigidly attached to the impact shield, or that the (respective) first part of the impact shield fastening means is rigidly fastened to the main body and the (respective) second part of the impact shield fastening means is rotatably (about a second impact shield axis) fastened to the impact shield, while the third impact shield rotation axis is formed by a cooperation between the (respective) first and second part of the impact shield fastening means and is separated from the first or second impact shield rotation axis.

The two (diverging) impact shield rotation axes may be defined by two left and two right connection points.

In the second and third embodiments, the child may rotate together with the impact shield (as opposed to a rotation of the child about the impact shield), and/or the one (or more) rotation axis (axes) may coincide with the child rotation axis. The centre of gravity of the child is preferably within a horizontal plane in which the one rotation axis (in the second embodiments) lies, or in which one or both (or even more) rotation axes lie (in the third embodiments) preferably slightly below such a plane.

In the third embodiments, the centre of gravity of the child may lie between the two horizontal planes in each of which one of the impact shield rotation axes lies, in particular such that the centre of gravity of the child lies above a horizontal plane in which the first impact shield rotation axis lies and/or below a horizontal plane in which the second impact shield rotation axis lies. In particular, it may be preferred that one of the two impact shield rotation axes is positioned further forward and/or further up relative to the other of the impact shield rotation axes, wherein the child's centre of gravity lies (preferably slightly) below the horizontal plane in which the upper or forward of the two impact shield rotation axes lies.

Generally (when the impact shield is rotatable relative to the main body about at least one axis), it may be preferred that a rotation downward about the at least one impact shield rotation axis exerts a force on the support section (or on the respective right and left support sections), wherein the force is (at least substantially) perpendicular to a support surface of the (respective) support section. This is particularly preferred for the third embodiment or a rotation about a lower and/or rear axis (as explained above).

The two rotation axes may be defined (as explained above) by two left and two right connection points. A first side of an angle A can be defined by a lateral projection of a line through the two left connection points, and a second side of the angle A can be defined by a lateral projection of a bottom of the main body. A may be less than 60°, preferably less than 50°, and/or A may be greater than 10°, preferably greater than 15°. In particular, A may be between 25° and 45°.

In general, it may be advantageous if a respective support section rises (at least substantially) from the rear to the front. In particular, the support section may form an angle B relative to a bottom of the main body (or a plane defined by the bottom of the main body) which is less than 70°, preferably less than 55° and/or greater than 10°, preferably greater than 15°. In particular, the angle may be between 25° and 45°.

If the child seat has a support leg (and/or if the child seat is equipped, e.g. in addition to the two Isofix connections, with a third rigid connection relative to the motor vehicle), it may be advantageous if the angles A and/or B are (at least slightly) smaller than indicated above, such as by 10° smaller (since a support leg and/or other third rigid connection) can reduce the rotation about the child seat rotation axis comparatively efficiently.

Preferably, the child seat or the system is configured such that the child's centre of gravity moves from a position below a plane in which a child rotation axis and/or an impact shield rotation axis lies to above opposite the respective plane during a (sudden) deceleration (that is traverses the plane).

Furthermore, the system or child seat may preferably be configured such that during an event of a (sudden) deceleration a rotation of the child relative to the main body in a direction under the impact shield and/or (subsequently) during or after the event of (sudden) deceleration in a direction above the impact shield.

In general, both aspects (a rotation of the child relative to the impact shield and a rotation of the child together with the impact shield) may be present in the child seat, depending on the implementation of a fastening of the impact shield to the main body. There may also be (at least some) translation of the impact shield relative to the main body (for example, when a belt via which the impact shield is attached to the main body is tightened). In this respect, an impact shield can be considered as at least substantially not (purely) translationally movable relative to the main body if it moves forward less than 10 cm, preferably less than 5 cm, during a (sudden) deceleration, in particular according to a frontal impact (“frontal crash”) as defined in UN ECE-R44 and/or UN ECE-R129, wherein the forward movement can be measured by measuring the corresponding foremost point of the impact shield.

The impact shield fastening means may be (at least substantially) formed rigidly, i.e. they may for example be formed of metal and/or plastic. Alternatively, the impact shield fastening means may be flexible (and/or dimensionally unstable) at least in sections, for example comprising at least one belt (or belt section), at least one band (or section thereof) or at least one cable (or component thereof) or the like. In the alternative, however, the impact shield fastening means preferably behave in a form-stable manner at least in sections during the sudden deceleration (such as, for example, a belt section that is stretched by the acting forces in this case, whereby any change in form only occurs at predefined points of the belt, for example by twisting and/or a kink).

The centre of gravity of the child may be the centre of gravity of the child actually seated in the child seat or the centre of gravity of a child of a size and/or weight for which the seat is designed (or approved).

For simplicity, a centre of gravity of a dummy can also be used as the centre of gravity, that is in a condition where the dummy is seated in the child seat and is held by it (according to regulations). In particular, in this context to a Q-dummy as in UN ECE-R129 (valid at the date of application or priority of the present description and/or at 31 Dec. 2013) can be understood. Q-dummies exist in the sizes Q0, Q1, Q1.5, Q3, Q6 and Q10, where the number after the Q indicates the (approximate) age of the child to which the dummy should correspond.

The present seat is intended, in particular, to be approved for children from a minimum height to a maximum height, wherein the minimum height may be at least 60 cm, preferably at least 75 cm, and/or the maximum height may be at most 130 cm, preferably at most 116 cm. Alternatively or additionally, the seat may be designed at least for dummies (or children replicated by the corresponding dummies) from Q1 or Q1.5 to Q6. In this respect, the respective centre of gravity shall also preferably be determined with such a dummy. If reference is made to the centre of gravity and certain conditions are required for it (in relation to other locations or places, in particular in relation to rotation axes), the conditions shall preferably apply to at least one of the dummies mentioned (preferably to at least three of the dummies, possibly to all dummies).

It is also to be noted that despite quite considerable deviations in the size of the dummy (or of the child to be simulated by the dummy) does not vary considerably, so that a point can also be used as the centre of gravity which (with at least essentially horizontal alignment of a seat surface) is at least about 19 cm away from this seat surface (distance=shortest distance) and optionally at the same time (at least about) 5-10 cm away from a back support surface (i.e. that surface of the child seat or of the back section against which the child's back rests).

If the back section and the seating section are adjustable in relation to each other (or an inclination of the back section can be adjusted in relation to the seating section), the respective conditions should preferably apply to at least one inclination position, further preferably at least to a partial range of an inclination adjustment range which in total amounts to at least half of a maximum possible inclination change, possibly for all inclination settings.

If the main body is adjustable in itself, for example in the case of child seats which have a base relative to which a seat element is adjustable (or an inclination of the main body can be adjusted), the respective conditions shall preferably apply to at least one inclination position, further preferably at least to a partial range of an inclination adjustment range which in total accounts for at least half of a maximum possible inclination change, optionally for all inclination settings.

If the impact shield is adjustable relative to the main body (rotationally and/or translationally), the respective conditions shall preferably apply to at least one setting, further preferably to at least half of all or all rotational adjustment possibilities and/or to at least half of all or all translational adjustment possibilities.

The impact shield may have an (active) protective device (for example an airbag). If this is the case (which is not mandatory), the respective conditions shall preferably apply at least to a case in which the active protective device is not triggered.

The mentioned standard UN ECE-R129 can be specifically the “Regulation No. 129—Uniform provisions concerning the approval of enhanced child restraint systems used on board of motor vehicles (ECRS)” or E/ECE/324/Riv.2/Add.128-E/ECE/TRANS/505/Riv.2/Add.128, for example as of 9 Jul. 2013 and/or 31 Dec. 2013 and/or just as of the priority or application date.

Specifically, the dummies of the manufacturer Humanetics can be used as dummies. Additional information can be found in the manuals of the manufacturer Humanetics (to which the standard UN ECE-R129 also refers).

If, in the present context, it comes to the rotation of the child (for example in relation to the vehicle seat or the main body), the rotation of the child's centre of gravity should be considered in particular (that is not, for example, a pitching movement of the head in relation to the torso or similar). If, in the event of a crash situation, individual parts of the child's body rotate relative to others (in particular the torso), this is to be disregarded in particular in that the point which continues to be considered as the centre of gravity is that which is the centre of gravity of the child or dummy in the initial state. However, it would also be conceivable to always use the current centre of gravity. By a preferred centre of gravity that does not (assumed) change is to be understood in particular a centre of gravity that should always be at the same place within the torso of the child and corresponds to the place where the centre of gravity is located when the dummy or the child is in its initial position (when the vehicle is stationary or in the usual driving situation).

Further embodiments result from the dependent claims.

In the following, the invention is described by means of execution examples which are explained in more detail with reference to the figures.

Hereby show:

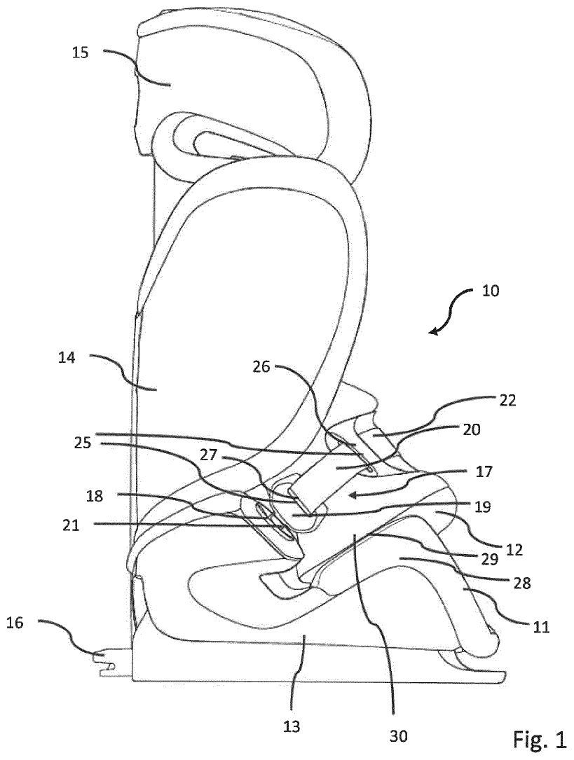

FIG. 1 a side view of a child seat according to the invention;

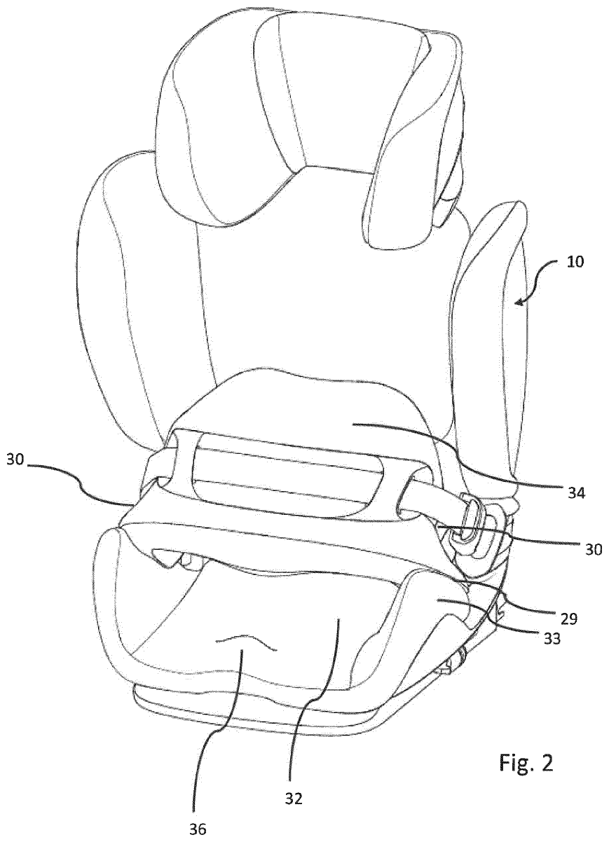

FIG. 2 an oblique view of the child seat according to FIG. 1;

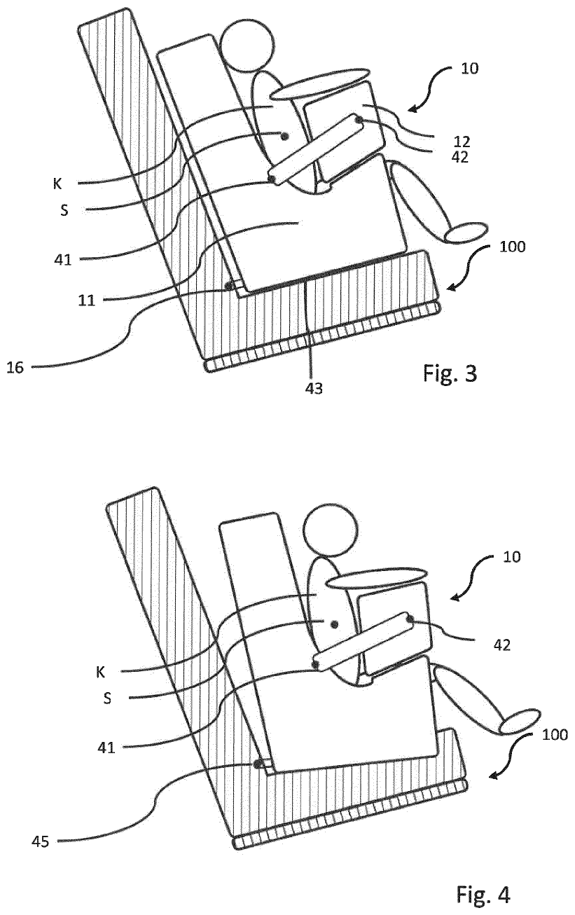

FIG. 3 a schematic sectional view of a child seat mounted on a vehicle seat;

FIG. 4 the child seat according to FIG. 3 during an impact situation;

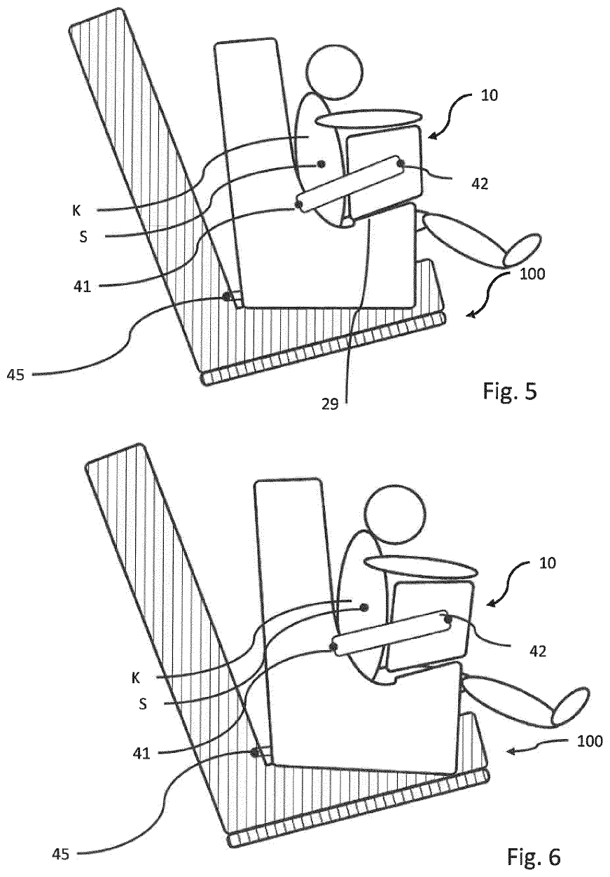

FIG. 5 the child seat according to FIGS. 3 and 4 as the impact situation progresses;

FIG. 6 the child seat according to FIGS. 3 to 5 during further progress of the impact situation;

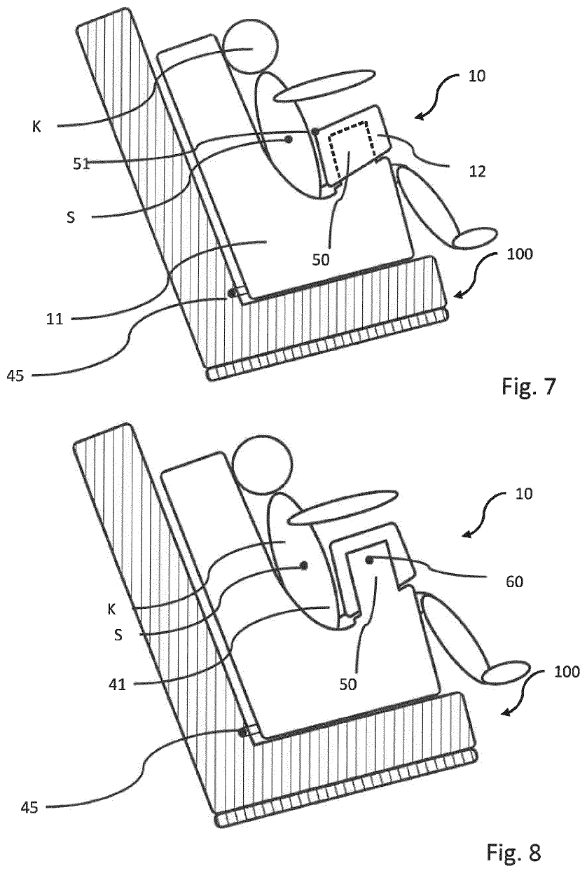

FIG. 7 a view according to FIG. 3 of a further embodiment of the child seat according to the invention;

FIG. 8 an illustration according to FIG. 3 of a further embodiment of the child seat according to the invention.

In the following description, the same reference numerals are used for identical and identically acting parts.

FIG. 1 shows a side view of a child seat 10 according to the invention, comprising a main body 11 as well as an impact shield 12. The main body 11 comprises a seating section 13 as well as a back section 14 with an (optional) headrest 15. The main body has a first fastening means 16 (here optionally comprising two Isofix anchoring structures). The impact shield 12 is attached or attachable to the main body 11 via a second fastening means (impact shield fastening means) 17. The second fastening means 17 comprises at least a first part 18 (specifically in the form of a belt buckle) as well as a second part 19 (comprising a corresponding belt tongue 21). A first part 18 and a second part 19 may be provided on each side (i.e. left and right respectively). However, it is also conceivable that the side not shown in FIG. 1 has a different fastening solution (for example, a non-detachable fastening or another detachable fastening).

In the present embodiment example, the (respective) first part 18 (belt buckle) is formed on the seating section 13, in particular integrally therewith. The (respective) second part 19 can, besides the belt tongue 21, also have a belt or belt section 20, which is or can preferably be placed (transversely) over the impact shield.

At least in the case of a frontal accident (in which it can be assumed that the belt 20 is tightened, alternatively instead of a per se flexible belt there could also be a rigid element or such an element could be considered at least here for further explanation), the impact shield 12 can rotate (relative to the main body 11) at two points (places or locations) (preferably on each side of the child seat). Firstly, the fastening of the belt 20 to the belt tongue 21 allows a rotation of the impact shield about this point or area (or a corresponding axis; as explained schematically below with reference to FIGS. 3 to 6, there this would correspond to the first impact shield rotation axis). Furthermore, the belt 20 is mounted in at least one belt guide mechanism 22 on the impact shield, whereby a further belt guide 22 is not recognisable in FIG. 1 (see also FIG. 2) and thus allows a further rotation possibility (which in the schematic representation according to FIGS. 3 to 6 corresponds to the second impact shield rotation axis, as explained further below).

Insofar as the individual rotation axes and their location are explained below, it shall be assumed (or presumed) that this preferably runs through the centre of respective recesses or guide and/or retaining structures 25 (and indeed in the lateral direction), even if the rotation axis should not be exactly there in each case (for example, taking into account a twisting of the belt). Generally, a respective rotation axis should be located where a centre of a structure that enables the corresponding rotation is located.

In other words, the belt 20 may be connected to the impact shield 12 at a respective third connection point (connection place) 26, and to the respective belt tongue or (when inserted) to the corresponding belt buckle or generally to the main body 11 at a respective fourth connection point (connection place) 27. Both the (respective) third connection point 26 and the (respective) fourth connection point 27 allow a rotation of the belt 20 about these locations and thus defines a respective rotation axis for the impact shield (impact shield rotation axis).

The seating section 13 preferably comprises (at least substantially) lateral wings 28, which (respectively) form a corresponding support surface 29 (for supporting the impact shield 12). Between the third and fourth connection points 26, 27, the belt 20 (in the side view shown or in a lateral projection) runs at least substantially parallel to the (respective) support surface 29 (or a contact line between the support surface 29 and a lateral section 30 of the impact shield 12).

FIG. 2 shows the seat according to FIG. 1 in an oblique view. A seating area 32 of the seating section 13 as well as a support section 33, which forms the respective support surface 29, on each side (left and right) can be seen here. Furthermore, it can be seen that the impact shield has a middle section 34 as well as (angled relative to it, in particular angled downwards) (on each side) a lateral section 30. The middle section 34 is designed to hold the child, in particular to restrain it in the event of an impact. The lateral sections 30 are provided to hold the child laterally (for example the child's thighs) and/or to allow the impact shield to be supported on the support section 33. An elevation (bulge) 36 is visible in a centre of a front section of the seating section 32. By this elevation 36 the child can be effectively restrained in effective cooperation with the specific impact shield.

FIG. 3 shows (highly) schematically a child seat 10 installed on a vehicle seat 100. The child seat 10 can be designed with further constructional details as the child seat shown in FIGS. 1 and 2, or can be designed in a different (specific) way.

The impact shield 12 can rotate relative to the main body 11 about a first impact shield rotation axis 41 as well as (at least in principle also about) a second impact shield rotation axis 42. The child seat 11 is attached to the vehicle seat 100 via the first fastening means 16 (specifically, this fastening can be designed as an Isofix fastening).

FIG. 3 shows a condition of the child seat 11 as well as vehicle seat 100 when the vehicle is stationary or driving normally (without unusually high accelerations). In such a state, the vehicle seat has an inclination 43 relative to the horizontal. Accordingly, the child seat 10 is also inclined at the same angle relative to the horizontal. The angle shown in FIG. 3 can also be smaller (or possibly larger) or even be zero. In any case, in the initial configuration according to FIG. 3, a centre of gravity S of a child K is (slightly) below a level of the second impact shield rotation axis 42 as well as above a level of the first impact shield rotation axis 41. Furthermore, the centre of gravity S is behind the second impact shield rotation axis 42 and in front of the first impact shield rotation axis 41.

In FIG. 4 the child seat from FIG. 3 is now shown at the beginning of an event of (sudden) deceleration (for example in the case of a frontal impact). The entire child seat 10 now begins to rotate around a child seat rotation axis 45 (in particular, specifically around the Isofix connections), so that a padding of the vehicle seat 100 is compressed. At the time shown in FIG. 4, rotation of the impact shield 12 relative to the main body 11 has not yet begun (at least not substantially). Rather, it is the case that child K and impact shield 12 are following the rotation of the entire child seat 10 or the main body 11 about the child seat rotation axis 45. In this case the centre of gravity S of the child K is still (at least slightly) below the second (upper) impact shield rotation axis 42 but less far below than in the position according to FIG. 3.

FIG. 5 shows a situation (briefly) after that of FIG. 4. The rotation of the child seat 10 around the child seat rotation axis 45 has continued. At the same time (especially since the previous course of the sudden deceleration event has taken slip out of the system, as well as due to the resistance of the cushion of the child seat, which is correspondingly accompanied by a decrease in a corresponding rotational speed), impact shield 12 as well as child K have started a rotational movement relative to the main body 11. The impact shield 12 does not rotate (at least substantially) about the first impact shield rotation axis 41 (in particular due to a support by the respective support surface 29). Rather, the impact shield rotates (at least substantially) about the second impact shield rotation axis 42. The child K, in turn, rotates together with the impact shield and thereby in a direction below the impact shield (or in such a way that a front end of the impact shield goes at least slightly upwards). The centre of gravity S of the child K is here (at least approximately) in a horizontal plane in which the second impact shield rotation axis 42 lies and furthermore (comparatively considerably) above a horizontal plane in which the first impact shield rotation axis 41 lies. Overall, the impact shield 12 and child K rotate counterclockwise (relative to the main body) in a view of the right side of the child seat 10. The relative rotation of the impact shield relative to the main body can be seen in particular in that the support surface is no longer aligned exactly parallel to the impact shield.

FIG. 6 shows a situation (briefly) after that in FIG. 5. The rotation of the child seat 10 about the child seat rotation axis 45 has now ended (for example, as the seating section of the child seat 10 reaches a fixed support structure of the motor vehicle seat, such as a frame thereof). At the same time, the impact shield 12 now rotates clockwise (as viewed from the right side of the child seat) about the second impact shield rotation axis 42 (as the centre of gravity S of the child K is now at least slightly above a horizontal plane in which the second impact shield rotation axis 42 lies). All in all, by this type of adjustment (including an occurring reversal of the direction of rotation) it is prevented in a simple manner that the impact shield or the child rotate excessively.

FIG. 7 shows (highly schematically) a child seat 10 in a normal position (when the vehicle is stationary or in a normal driving situation without excessive acceleration), which is mounted on a vehicle seat 100 (analogous to FIGS. 3 to 6). The child seat 10 and vehicle seat 11 can generally be designed as shown in FIGS. 1 and 2 and FIGS. 3 to 6 respectively (although this is not mandatory). Differences to this are explained below.

In contrast to the embodiment according to FIGS. 3 to 6, the impact shield 12 is here fixed (at least stationary) relative to the main body 11. Specifically, the impact shield 12 can be brought into engagement with the main body 11, where for this purpose (for example as shown in FIG. 7) a (e.g. upwardly projecting) projection 50 can be provided (alternatively or additionally, the impact shield 12 can also have a corresponding projection which can be brought into engagement with a recess on the main body). Of course, a stationary connection can be realised in another way (that is in particular a connection that can be adjusted in such a way that at least no rotation, possibly also no translation is possible). The impact shield 12 has a rear upper edge defining a child rotation axis 51 (about which the child rotates in the event of forward acceleration relative to the vehicle seat 100). A centre of gravity S of the child K is below this child rotation axis. Also in FIG. 7 (as explained in connection with FIGS. 3 to 6), the child seat 100 can preferably rotate about a child seat rotation axis 45, so that the centre of gravity S of the child K as well as the child rotation axis 51 move against each other with progressing deceleration process (in particular before, possibly shortly after, a rotation about the child rotation axis has begun), so that the rotation of the child K about the child rotation axis 51, if necessary, occurs in a direction above the impact shield (or is inverted from a rotation in a direction below the impact shield 12 into a direction above the impact shield 12) whereby in the case of a rotation below the impact shield 12 a corresponding child rotation axis can be defined by a lower rear edge of the impact shield 12.

FIG. 8 shows a further (highly schematic) illustration of a further embodiment of a child seat in a normal use situation, installed on a vehicle seat 100. Here, too, the child seat 10 can, possibly, be designed as explained in connection with FIGS. 1 and 2 or FIGS. 3 to 6 (taking into account the deviations explained below).

Here, the impact shield 12 is rotatable relative to the main body 11 about only a single impact shield rotation axis 60. To this end, specifically (deviating solutions are possible) a projection 50 can be provided on the main body (possibly at least in a side view or formed in cross-section as in FIG. 7), whereby the impact shield 12 is mounted on this projection, for example via a rod and/or at least one pin. Although the centre of gravity S of the child K is below the impact shield rotation axis 60, the rotation of the child seat 10 about the child seat rotation axis 45 may move the centre of gravity S and the impact shield rotation axis 60 (which may simultaneously form a child rotation axis) relative to each other before (or shortly after) the rotation about the impact shield rotation axis 60 has begun, such that the rotation of the child about the impact shield rotation axis 60 occurs (immediately) in a direction above the impact shield 12, or is inverted from a rotation in a direction below the impact shield (about an axis which may be defined by a rear lower corner of the impact shield 12) to a rotation in a direction above the impact shield.

At this point, it should be noted that all of the parts described above, taken individually and in any combination, in particular the details shown in the drawings, are claimed as essential to the invention. Modifications thereof are familiar to the skilled person.

Furthermore, it is pointed out that the broadest possible scope of protection is sought. In this respect, the invention defined in the claims can also be specified by features which are described with further features (even without these further features necessarily being included). It is explicitly pointed out that round brackets and the term “in particular”/“particularly” are intended to emphasise the optionality of features in the respective context (which does not mean, conversely, that a feature is to be regarded as mandatory in the corresponding context without such identification).

### REFERENCE SIGNS

K child
S centre of gravity
10 child seat
11 main body
12 impact shield
13 seating section
14 back section
15 head restraint
16 first fastening means (child seat fastening means)
17 second fastening means (impact shield fastening means)
18 first part
19 second part
20 belt
21 belt tongue
22 belt guide
25 recess
26 third connection point
27 fourth connection point
28 wing
29 supporting surface
30 lateral section
32 seating area
33 support section
34 middle section
36 elevation
41 first impact shield rotation axis
42 second impact shield rotation axis
43 inclination
45 child seat rotation axis
50 projection
51 child rotation axis
60 impact shield rotation axis
100 vehicle seat

1. A system comprising a motor vehicle and a child seat arranged on a vehicle seat of the motor vehicle,
wherein the child seat has a main body for accommodating a child and an impact shield for holding the child,
wherein the child seat is configured such, that a center of gravity of the child, at least in an initial state at a beginning of a sudden deceleration of the motor vehicle or at a beginning of a rotation of the child relative to the vehicle seat or at a beginning of a rotation of the child relative to the main body during a sudden deceleration of the motor vehicle is at least approximately at or below a level at which a child rotation axis is located about which the child rotates relative to the main body as soon as the child starts to rotate relative to the main body, or
is at least approximately at or below a level at which at least one impact shield rotation axis is located about which the impact shield can rotate relative to the main body.

2. The system according to claim 1,
wherein
the main body comprises at least one seating section which defines a seating area on which the child can sit and lateral support sections, for laterally supporting the child, or
wherein the impact shield comprises at least one middle section for holding the child and lateral sections which support themselves on the supporting sections of the main body.

3. The system according to claim 1,
wherein
a front section of a seating area of the main body has a centrally located elevation for restraining the child.

4. The system according to claim 1,
wherein
the child seat main body has a first fastening means, an Isofix fastening means or a latch fastening means, for fastening the child seat to the vehicle seat, or
in that the child seat main body or impact shield has a guide mechanism for receiving a motor vehicle belt in such a way that the child seat is fastenable to the motor vehicle seat, or
in that the child seat main body is rotatable about a child seat rotation axis or main body rotation axis relative to the vehicle seat.

5. The system according to claim 1,
wherein
the impact shield is at least substantially rigidly connected or connectable to the main body, or at least partially detachably connected or connectable to the main body relative to a rotation or translation.

6. The system according to claim 1,
wherein
the child rotation axis lies on an upper surface or an inner surface of the impact shield at the beginning of the child's rotation, or
in that the child rotation axis displaces itself relative to the impact shield, or in that the child rotation axis remains stationary relative to the impact shield.

7. The system according to claim 1,
wherein
the impact shield is rotationally movable without allowing a pure translation, the impact shield is at least partially detachably connected or connectable to the main body, the impact shield is rotationally movable about exactly one impact shield rotation axis or the impact shield is rotationally movable about exactly two impact shield rotation axes or the impact shield is rotationally movable about more than two impact shield rotation axes connected or connectable to the main body, wherein preferably at least one impact shield rotation axis is at least temporarily identical with the child rotation axis.

8. The system according to claim 1,
wherein
the child seat comprises at least one impact shield fastening means for fastening the impact shield to the main body, wherein the impact shield fastening means:
allows a rotation of the impact shield about exactly one or exactly two or more than two impact shield rotation axes, or
has at least one first section, or at least one first section on each side of the main body, which is linked or linkable to the main body, or at least one second section, or at least one second section on each side of the impact shield, which is linked or linkable to the impact shield, or
has at least one or exactly one or two articulated connection(s) in a connecting section between the main body and the impact shield, or
is formed rigidly at least in sections, completely, or apart from corresponding articulated connections, or
is formed dimensionally unstable at least in sections, completely, or has at least one belt section.

9. The system according to claim 1,
wherein
the impact shield is rotatable relative to the main body about at least one first impact shield rotation axis or at least one second impact shield rotation axis, which deviates from the first impact shield rotation axis, at least at a beginning of the rotation of the child relative to the vehicle seat or at a beginning of the rotation of the child relative to the main body, and lies above a level of the first impact shield rotation axis or lies in front of the first impact shield rotation axis or coincides with the first impact shield rotation axis, and wherein:
the first impact shield rotation axis is defined by a link of a connecting device for connecting the main body and the impact shield to the main body, or by a link to the impact shield; or
the second impact shield rotation axis is defined by a link of the connecting device for connection between main body and impact shield to the impact shield; or
the center of gravity of the child lies at least at the beginning of a rotation of the child at least approximately at the level of or below a level of the second impact shield rotation axis or behind the second impact shield rotation axis; or
the center of gravity of the child, at least at the beginning of a rotation of the child, lies at least approximately at the level of the first impact shield rotation axis or above or below a level of the first impact shield rotation axis or in front of the first impact shield rotation axis; or
the main body has an underside, wherein a connecting line which connects and is perpendicular to the first and second impact shield rotation axes, has an angle of less than 60° and more than 10° relative to the underside of the child seat or is aligned at least substantially parallel to at least one support surface on which the impact shield is supported on the main body; or
a rotation of the impact shield about the first impact shield rotation axis causes the impact shield to exert a force on the support surface on which the impact shield is supported on the main body, said force directed at least substantially perpendicular to the support surface; or
the first impact shield rotation axis is arranged above a lower end of the impact shield or above a lower end of the support surface on which the impact shield is supported on the main body; or
the first or second impact shield rotation axis is arranged above a child seat rotation axis, main body rotation axis, about which the child seat or its main body rotates relative to the vehicle seat.

10. The system according to claim 1,
wherein
the child seat is configured such that a center of gravity of the child during the rotation remains at least approximately at a level of the child rotation axis or at least one impact shield rotation axis or moves upwards relative to the level of the child rotation axis or at least one impact shield rotation axis, from an initial position at least slightly below this level to an intermediate or final state at least slightly above this level.

11. The system according to claim 1,
wherein
the child seat is configured in such a way that during a progressing rotation of the child at least or exactly one reversal of the direction of rotation of the child relative to the main body or the motor vehicle occurs.

12. The system according to claim 1,
wherein
the child is provided and positioned and secured, in the child seat.

13. A child seat according to claim 1, for mounting on a motor vehicle seat, wherein the child seat comprises a main body for accommodating a child and an impact shield for holding the child, wherein the child seat is configured in such a way that a center of gravity of the child, at least in an initial state at the beginning of a rotation of the child or at the beginning of a rotation of the child relative to the main body in the event of a deceleration of the motor vehicle,
is at least approximately at or, slightly below a level at which a child rotation axis lies about which the child rotates relative to the main body as soon as the child starts to rotate relative to the main body, or
at least approximately at or, preferably slightly below a level at which at least one impact shield rotation axis lies,
at least when the child seat is arranged on a motor vehicle seating surface in such a way that the child seat is inclined at an angle of at least 0° and at most 30° relative to horizontal.

14. (canceled)

15. A method of arranging a child seat on a vehicle seat of a motor vehicle, with provision of a system according to claim 1, wherein the child seat comprises a main body for accommodating a child and an impact shield for holding the child, wherein the child seat is configured and arranged such that a center of gravity of the child, at least in an initial state at a beginning of a rotation of the child or at a beginning of a rotation of the child relative to the main body during a deceleration of the motor vehicle,
is at least approximately at or, slightly below a level at which a child rotation axis is located about which the child rotates relative to the main body as soon as the child starts to rotate relative to the main body, or
is at least approximately at or, slightly below a level at which at least one impact shield rotation axis lies.
